(19) United States
(12) Patent Application Publication
(10) Pub. No.: US 2023/0125616 A1
(43) Pub. Date: Apr. 27, 2023

(54) Concept for Determining and Handling a Mismatch Between an Expected and a Current System Configuration

(71) Applicant: Intel Corporation, Santa Clara, CA (US)

(72) Inventors: Duncan GLENDINNING, Chandler, AZ (US); Joshua BOELTER, Portland, OR (US); Tirumaleswara Rao KOLIPAKULA, Bangalore (IN); Vrukesh PANSE, Bengaluru (IN); Abhishek PALIWAL, Bangalore (IN); Nupur NARAYAN, Bangalore (IN); Rajaram REGUPATHY, Bangalore (IN); Pallavi POTNIS, Maharashtra (IN)

(21) Appl. No.: 18/145,866

(22) Filed: Dec. 23, 2022

(51) Int. Cl. G06F 9/445; G06F 9/4401

(52) U.S. Cl. CPC G06F 9/44505; G06F 9/4418

(57) ABSTRACT

Various examples relate to a concept for determining and handling a mismatch between an expected and a current system configuration. An apparatus for a computer system comprises interface circuitry, machine-readable instructions and processing circuitry to execute the machine-readable instructions to obtain information on an expected system configuration of the computer system from a protected storage of the computer system, determine information on a current system configuration of the computer system, compare the expected system configuration with the current system configuration, and provide information on a mismatch via an output device of the computer system if there is a mismatch between the expected system configuration and the current system configuration.

### BACKGROUND

Under modem computing workloads, a large amount of interaction is required between the various components of the computer systems, e.g., between modules of a System on a Chip (SoC) or between hardware components of a computer system. This brings increasing challenges for device manufacturers to ensure the system can proactively and consistently manage the state of its modules to meet the end-user expectations of the product.

### BRIEF DESCRIPTION OF THE FIGURES

Some examples of apparatuses and/or methods will be described in the following by way of example only, and with reference to the accompanying figures, in which

FIGS. 1a and 1b show schematic diagrams of examples of an apparatus or device for a computer system, and of a computer system comprising such an apparatus or device;

FIG. 1c shows a flow chart of an example of a method for a computer system;

FIG. 2 shows a schematic drawing of an example of a typical set-up of a client device;

FIG. 3 shows an example of an implementation of primary and secondary telemetry data in a client device; and

FIG. 4 shows a flow chart of an example of the primary and secondary telemetry data flow.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

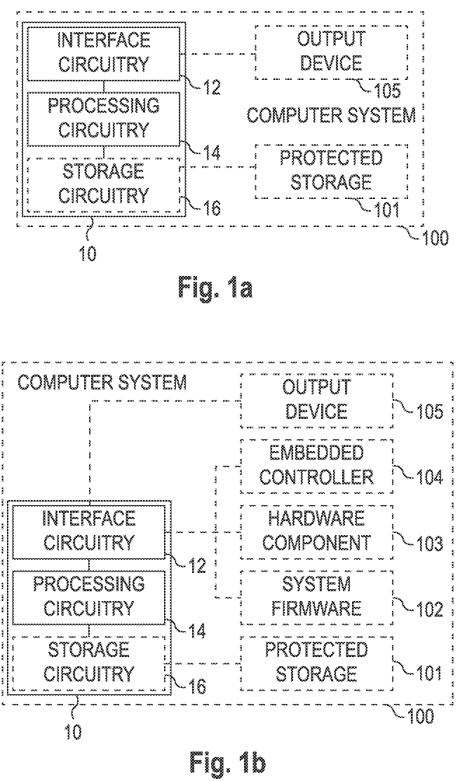

FIGS. 1a and 1b show schematic diagrams of examples of an apparatus 10 or device 10 for a computer system 100, and of a computer system comprising such an apparatus or device. The apparatus 10 comprises circuitry to provide the functionality of the apparatus 10. For example, the circuitry of the apparatus 10 may be configured to provide the functionality of the apparatus 10. For example, the apparatus 10 of FIGS. 1a and 1b comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may provide the functionality of the apparatus, in conjunction with the interface circuitry 12 (for exchanging information, e.g., with other components inside or outside the computer system 100 comprising the apparatus or device 10, such as a protected storage 101, a system firmware 102, a hardware component 103, an embedded controller 104 or an output device 105) and the storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIGS. 1a and 1b comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

The processing circuitry 14 or means for processing 14 is to obtain information on an expected system configuration of the computer system 100 from the protected storage 101 of the computer system. The processing circuitry 14 or means for processing 14 is to determine information on a current system configuration of the computer system. The processing circuitry 14 or means for processing 14 is to compare the expected system configuration with the current system configuration. The processing circuitry 14 or means for processing 14 is to provide information on a mismatch via the output device 105 of the computer system if there is a mismatch between the expected system configuration and the current system configuration.

FIG. 1c shows a flow chart of an example of a corresponding method for a computer system, such as the computer system 100. The method comprises obtaining 110 the information on the expected system configuration of the computer system 100 from the protected storage 101 of the computer system, The method comprises determining 120 the information on the current system configuration of the computer system. The method comprises comparing 130 the expected system configuration with the current system configuration. The method comprises providing 160 the information on the mismatch via an output device of the computer system if there is a mismatch between the expected system configuration and the current system configuration. For example, the method may be performed by the computer system 100, e.g., by the apparatus 10 or device 10 of the computer system 100.

In the following, the functionality of the apparatus 10, the device 10, the method and of a corresponding computer program is illustrated with respect to the apparatus 10. Features introduced in connection with the apparatus 10 may likewise be included in the corresponding device 10, method and computer program.

The present disclosure relates to a concept for determining and handling a mismatch between an expected and a current system configuration. In the proposed concept, a reference state of the system configuration is defined and used as a point of comparison during operation of the computer system, to be compared with the current state of the system configuration. In this context, the system configuration may relate to various aspects of the computer system. In particular, the system configuration may relate to a hardware configuration of the computer system. Accordingly, the information on the expected system configuration may comprise information on an expected hardware configuration of the computer system, e.g., with respect to hardware components present within the computer system. For example, the information on the expected system configuration may comprise a representation of an enumeration of hardware components present in the computer system (e.g., of Advanced Configuration and Power Interface (ACPI) namespace objects representing hardware components, or of a corresponding device tree). In addition, the information on the expected system configuration may comprise information on a driver and/or a firmware being used to operate the respective hardware components. In other words, the information on the expected system configuration may comprise information on driver versions and/or firmware versions being used to operate the hardware components of the computer system.

In the present context, the term “hardware components of the computer system” is being used. This means that the proposed concept, at least primarily relates, to hardware components that are internal to the computer system, such as hardware components of the System on a Chip of the computer system, one or more hardware components that are hosted by a mainboard of the computer system, a processor of the computer system, Random Access Memory of the computer system, (flash) storage of the computer system, one or more non-hot-pluggable extension cards of the computer system etc. In other words, the expected (and also current) system configuration relate to internal components of the computer system, i.e., to non-peripheral components of the computer system. Peripheral components, such as external input devices, thumb drives or port extension docks may be omitted from the system configuration.

The collection of information about the system configuration is known from other concepts as “telemetry”, i.e., remote measurements, as the system configuration is, in these other concepts, merely collected locally, but evaluated centrally. For example, such telemetry is used in device management platforms, which are primarily used in professional contexts, such as large companies, but also in educational context, to manage a large fleet of devices, and in particular computer systems. In the present concept, a different approach is chosen -in the present concept, the respective information on the system configuration is used and collected locally, e.g., without transmitting said information to a server for a centralized administration of the computer system. Nonetheless, as the term is widely used in the field, the respective information on the system configuration may be denoted telemetry data. In other words, the information on the expected system configuration and the information on the current system configuration may comprise telemetry data.

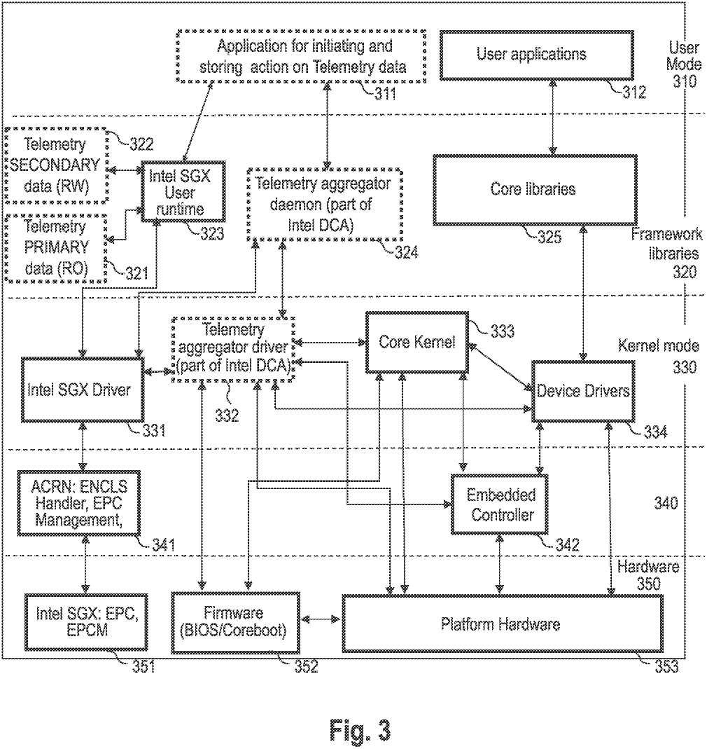

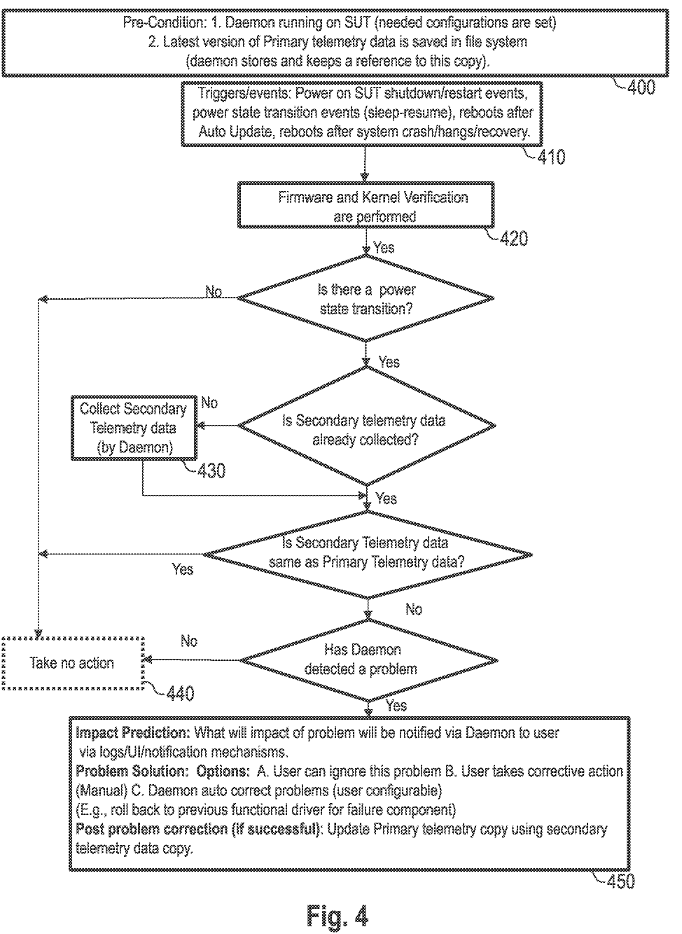

The proposed concept is centered around the information on the expected system configuration of the computer system 100. In the context of FIGS. 3 and 4, this information is also called primary telemetry data. In the present context, this information on the expected system configuration is meant to be static or quasi-static (or immutable/quasi-immutable), as it never (or only rarely) changes over the lifetime of the computer system. To avoid accidental or purposeful manipulation of the information on the expected system configuration, it is stored in the protected storage 101 of the computer system. As shown in FIG. 1c, this protected storage may be part of the storage device 16 of the apparatus 10. Alternatively, the protected storage may be part of the system firmware 102 (shown in FIG. 1b) of the computer system (which may correspond to the Unified Extensible Firmware Interface (UEFI), Basic Input/Output System (BIOS) or Coreboot of the computer system, for example). Yet alternatively, the protected storage may be part of a file system used by an operating system (OS) of the computer system, e.g., a part that is included in a read-only partition or a part that is protected via permissions or an access control list managed by the operating system. Regardless of implementation, the protected storage may be storage that cannot be modified, at least without elevated system privileges. For example, the protected storage 101 may be a read-only storage of the computer system. Alternatively, the protected storage 101 may be a storage that may be overwritable (only) by an administrator of the computer system.

As outlined above, the information on the expected configuration of the may be static or quasi-static information, i.e., information that is never or only occasionally overwritten (depending on implementation). For example, if the information on the expected system configuration only relates to the hardware components present within the computer system, the information on the expected system configuration might never be changed as, in most computer systems, the hardware does not change over the lifetime of the computer system. For example, the expected system configuration may be a factory-defined system configuration of the computer system. In these cases, the information on the expected system configuration might only be overwritten in case of a repair or an upgrade of the computer system, e.g., when a removable component is replaced or added to the computer system in the field (e.g., a RAM upgrade, installation of wireless card etc.). Thus, an administrator of the computer system may be allowed to modify the information on the expected system configuration in such an event. In another scenario, such a modification may be performed more often. This is the case if the information on the expected system configuration also comprises information on the driver or firmware versions being used to operate the respective hardware components, more frequent updates to the information on the expected system configuration may be applied, e.g., after the new driver or firmware version has proven to be stable. In both cases, the expected system configuration may be a factory-defined system configuration of the computer system that is modifiable by an administrator of the computer system, e.g., after an upgrade or repair of a hardware component of the computer system, after installing a new removable component, or after updating a driver of firmware of a hardware component.

During the lifetime, the expected system configuration is compared with the current system configuration (which is also denoted secondary telemetry data in connection with FIGS. 3 and 4). For this purpose, the information on the current system configuration is collected. The information on the current system configuration represents the current state of the computer system, i.e., the state of the system at the time the information on the current system is determined, e.g., with respect to the hardware components that are part of the computer system, and/or with respect to the drivers and/or firmware being used to operate the hardware components. As the information on the current system configuration is to be compared with the information on the expected system configuration, both may comprise similar, or at least comparable (in the sense of being suitable for comparing one with the other) information.

While the information on the expected system configuration may initially be compiled in the factory (or during configuration) of the computer system, the information on the current system configuration may be determined anew (e.g., from scratch, or at least partially from scratch) at various points during the lifetime of the computer system. In general, errors often occur during transitions between different states, e.g., when the computer system wakes from sleep, or after the computer system cold boots. Accordingly, the processing circuitry may determine the information on the current system configuration after a power state transition of the computer system. In this context, the power state may correspond to the power states as defined in the ACPI, e.g., from S0 (active/working) to S5 (soft off), or from G0 (active/working) to G3 (mechanical off), via different sleep states (G1, S0ix-S4) and the soft-off state (G2, S5). In other words, the transition may occur between soft off, sleeping and active, of between the different states (e.g., from S5 (soft-off) to S0 (active), or S3 (sleep, suspend to RAM) to S0 (active), or from S1 (power on suspend) to S0 (active)). In particular, the processing circuitry may determine the information on the current system configuration after the computer system transitions from a sleep state (or soft-off state) to an active state. Another type of power state transition occurs when the computer system is cold-booted. For example, the processing circuitry may determine the information on the current system configuration after or during a boot process of the computer system. Alternatively, or additionally, the information on the current system configuration may be updated at regular intervals (e.g., hourly, or daily). In other words, the processing circuitry may determine the information on the current system configuration according to a pre-defined schedule. As a final option, the information on the current system configuration may be determined after an error occurs (e.g., after a crash of the system).

As the determination of the information on the current system configuration has a non-negligible overhead, the collection of the information may be foregone if it would (severely) negatively impact the operation of the computer system. For example, if the computer system is a laptop computer (or another battery-powered device, such as a tablet computer or a smartphone), the determination of the information on the current system configuration may be foregone if the computer system is operating on battery power, or if the charging level is below a threshold. In other words, the processing circuitry may determine the information on the current system configuration when a power condition is met, e.g., if the computer system is not operating on battery power/being supplied by an external power supply, or if the charging level is above or at least the threshold.

To determine the information on the current system configuration, various sources within the computer system may be queried. For example, to obtain the hardware components being enumerated by the computer system (e.g., by the system firmware, via the ACPI), the system firmware may be queried. In other words, the processing circuitry may determine the information on the current system configuration by querying the system firmware 102 of the computer system. Another source is the kernel of the operating system. For example, hardware components being enumerated by the computer system may be determined via the operating system, e.g., by querying the list of active hardware components being enumerated by the kernel of the operating system. The kernel of the operation system may also be queried to determine the driver versions being used to operate the hardware components. In other words, the processing circuitry may determine the information on the current system configuration by querying the kernel of the operating system of the computer system. Additionally, or alternatively, based on the information on the expected system configuration, the respective hardware components may be queried individually. The latter may also be done to obtain information on a firmware version being used to operate the respective hardware components. In other words, the processing circuitry may determine the information on the current system configuration by querying a hardware component 103, i.e., the respective hardware component, of the computer system. This may be done directly, or via the respective driver being used to operate the hardware component. Accordingly, the processing circuitry may determine the information on the current system configuration by querying a driver of a hardware component 103 of the computer system, which may also be used to determine the version of the driver. In some cases, multiple hardware components are being managed by an intermediate entity, such as an embedded controller (i.e., a controller that is embedded in the computer system). Accordingly, the processing circuitry may determine the information on the current system configuration by the embedded controller 104 of the computer system. In summary, and with respect to the corresponding method, as further shown in FIG. 1c, the method may comprise determining 120 the information on the current system configuration by querying 125 at least one of a system firmware 102 of the computer system, a hardware component 103 of the computer system, an embedded controller 104 of the computer system, a kernel of an operating system of the computer system and a driver of a hardware component 103 of the computer system.

Once the information on the expected system configuration is obtained (e.g., read-out) from the protected storage and the information on the current system configuration is determined, the two may be compared (as they contain “comparable” information). In particular, during comparison of the two, mismatches may be detected and used to trigger one or more subsequent operations. In particular, in many cases, a mismatch does not necessarily have a large impact, in particular if driver versions and/or firmware versions are also compared. Therefore, the likely (i.e., projected, predicted) impact of the mismatch may be determined in a first operation. For example, the processing circuitry may determine, based on a data storage with known impacts (which may be stored in the storage circuitry 16), information on a likely impact of the mismatch. Accordingly, as further shown in FIG. 1c, the method may comprise determining 140, based on a data storage with known impacts, information on a likely impact of the mismatch. In some cases, e.g., if a hardware component is present in the expected configuration and missing in the current configuration, if a hardware component is missing in the expected configuration and present in the current configuration, and if a hardware component has a different configuration between the expected configuration and the expected configuration, the likely impact may be considered to be large (i.e., high), as these cases indicate a hardware failure, firmware failure, or driver failure or that hardware is being installed or replaced (and thus best addressed by updating the expected configuration). Another scenario where the impact is considered to be large is when the determination of the information on the current configuration has been triggered by a crash. In this case, any change, regarding hardware component, driver version or firmware versions that temporally coincides with the crash (e.g., at most 15 minutes before the crash, or at most an hour before the crash, or at most 3 hours before the crash, or at most 12 hours before the crash, or at most 24 hours before the crash) may be considered to have a large impact.

In many cases, knowledge may be compiled on how to deal with various types of mismatches. For example, some types of mismatches (such as a hardware component not being included in the current system configuration, but in the expected system configuration) may be addressed (in an attempt to correct the mismatch) by hard-resetting the hardware component or by rebooting the computer. Other types of mismatch (e.g., a driver or firmware version mismatch that temporally coincides with a crash) may be addressed by restoring the driver version or firmware version to a previous state (if possible). The processing circuitry may determine, based on a data storage with proposed mitigations (which may be stored in the storage circuitry 16), information on a proposed mitigation for mitigating the mismatch. Accordingly, as further shown in FIG. 1c, the method may comprise determining 150, based on a data storage with proposed mitigations, information on a proposed mitigation for mitigating the mismatch. For example, the data storage with proposed mitigations may include, for different types of mismatch (firmware/driver version mismatch coinciding with crash, hardware component present in the expected configuration and missing in the current configuration, hardware component missing in the expected configuration and present in the current configuration, hardware component having a different configuration between the expected configuration and the expected configuration), information on a proposed mitigation.

If a mismatch is detected (and is judged to have a large, or at least moderate impact), a user of the computer system is notified of the mismatch. In particular, the processing circuitry is to provide information on the mismatch via an output device 105 of the computer system if there is a mismatch between the expected system configuration and the current system configuration. For example, the processing circuitry may provide the information on the mismatch via a display of the computer system, e.g., as a notification, via a notification facility of the operating system of the computer system. Additionally, or alternatively, an alert may be played via a speaker of the computer system. The information on the mismatch may include various pieces of information, e.g., information on the mismatch having occurred (e.g., a representation of the respective configuration portions included in the expected and current configuration), information on the likely impact with the information on the mismatch, and/or information on the proposed mitigation with the information on the mismatch. For example, the user may be provided with an option to ignore the mismatch, to manually take corrective action (e.g., by rebooting the computer system or reinstalling an earlier driver), or to automatically (i.e., controlled by the proposed apparatus, device, method, or computer program) take corrective action (e.g., by automatically rebooting the computer system, by resetting a hardware component, or by automatically reverting to an older driver version or older firmware version).

As outlined above, not every mismatch may be worth notifying the user. In particular, if a driver or firmware is updated, and no crash occurs, no notification may be necessary. In other cases, e.g., cases with a large impact, the information on the mismatch may be provided. For example, the information on the mismatch may be provided in at least one of the following cases if a hardware component is present in the expected configuration and missing in the current configuration, if a hardware component is missing in the expected configuration and present in the current configuration, if a hardware component has a different configuration between the expected configuration and the expected configuration, and if a driver or firmware version is different and a crash has occurred in temporal coincidence with the update to the driver or firmware version.

As outlined above, in some cases, it may be beneficial to update the (quasi-static) information on the expected system configuration. This may be the case if hardware is replaced or added to the computer system, of if a driver or firmware is updated and is proven to be working well. In these cases, an update may be applied. For example, the processing circuitry may detect a change in the system configuration of the computer system, authenticate an administrator of the computer system, and overwrite the expected system configuration based on the detected change in the system configuration and based on the authentication of the administrator of the computer system. Accordingly, as further shown in FIG. 1c, the method may comprise detecting 132 a change in the system configuration of the computer system, authenticate 136 an administrator of the computer system, and overwriting 136 the expected system configuration based on the detected change in the system configuration and based on the authentication of the administrator of the computer system. In the case of updates to the driver or firmware, instead of requiring administrator authentication, a time-based approach may be used. For example, if, after a driver or firmware has been updated, no crash or other mismatch in the hardware configuration is detected within a pre-defined time-interval (e.g., a day, or a week), the expected system configuration may be overwritten. In other words, the processing circuitry may detect a change in a driver version or firmware version of the system configuration of the computer system, wait for a pre-defined time interval, and overwrite the expected system configuration based on the detected change in the system configuration if no crash or mismatch in the hardware configuration (i.e., portions of the system configuration related to hardware components, and not to driver/firmware thereof) has been detected in the pre-defined time-interval.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be desktop computer, a laptop computer, a tablet computer, a server computer, or a mobile device, such as a smartphone.

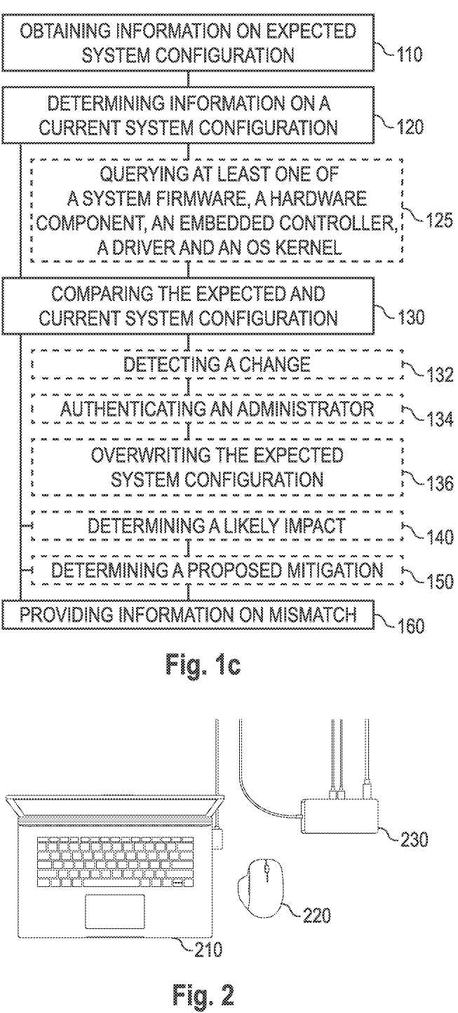

More details and aspects of the apparatus, device, method, computer program and computer system are mentioned in connection with the proposed concept, or one or more examples described above or below (e.g., FIGS. 2 to 4). The apparatus, device, method, computer program and computer system may comprise one or more additional optional features corresponding to one or more aspects of the proposed concept, or one or more examples described above or below.

Various examples of the present disclosure relate to a concept for defining a software-readable expected system configuration. For example, the software-readable “expected system configuration” may be defined at time of manufacture and/or time of boot. Higher order software (e.g., (Basic Input/Output Software, a system firmware implementation), OS (Operating System), Applications) can compare against the observed configuration. This may allow the higher-order software to discover discrepancies between the intended / expected configuration and the actual configuration. For example, a missing or non-enumerated USB (Universal Serial Bus) end-point may be discovered through this discrepancy. The utility of the proposed concept invention may apply from early manufacturing validation (e.g. Processor Platform Validation, PPV) through to end-user system use.

Client devices, such as the computer system introduced in connection with FIGS. 1a to 1c) are designed and developed to have an efficient interaction between hardware and software. However, due to workloads being executed and intricately timing-dependent flows between different components, the client device may occasionally lose track of some device implementation capabilities. As a result, a device states may enter an undesired, bad, or unusable state.

The present disclosure proposes for providing secured and trusted read-only and readable telemetry data of system configuration that may be used to help identify components and services which are in undesired state in a computing system.

The proposed concept may leverage dynamically collected Telemetry data of expected device configuration (e.g., the information on the expected system configuration) for key product requirements and specifications while taking user privacy into consideration, working in tandem with hardware and OS to probe the enumeration information and state of on-device components/drivers/modules to ensure and highlight any footprint of uninitialized or undesired/bad state of modules which potentially impact boot time, runtime functionality, overall system performance and power consumption during usages of client device, thus providing better user experience.

The proposed concept may perform analysis of telemetry data of device configuration on the client device itself with a prestored invariant manifest telemetry data (i.e., the information on the expected hardware configuration). This disclosure might not propose an end user tool, but rather means to provide real-time feedback to an end user about potential issues in the device that are expected to be part of platform accessible via Advanced Configuration and Power Interface (ACPI) framework.

There may be a huge demand to have consistently highly scalable compute performance and power-efficient code to execute on client computing devices across its usages throughout the lifetime and power state transitions, with expectation of maintaining optimum power and performance for all user workloads. To meet these requirements on a client device, there are diverse architectural implementations of Central Processor Unit (CPU), Graphics Processing Unit (GPU), Audio/Video accelerators and Artificial Intelligence (AI) engines.

These System on a Chip (SoC) components use software components such as dedicated firmware, kernel threads/processes, OS (Operating System) threads, device drivers, software libraries, daemon services and user space applications to perform their tasks. These software modules each have their own lifecycle of loading, initializing, binding, running, interrupted state, sleeping state, stopped state, zombie, unbinding, unloading, register, unregister, cleanup, removing and such.

The proposed concept provides a mechanism for ensuring that, after auto-updates or power state transitions during normal usage, the end-user is notified of any unexpected outage of modules, services or components even if they are not under use. Any unexpected behavior resulting from faulty hardware components and incorrect states of software components on client device can create a bad user experience due to a lack of feedback mechanism.

In an OS which supports auto-update, the root file system may be mounted as read-only, and the device state may be stored on a read-write partition. This allows clear sandboxing of auto-updatable system OS and its components; and user data which does not get affected with auto-updates. In case of failure of the auto-update, such partitioning also allows device to fall back to last working state.

FIG. 2 shows a schematic drawing of an example of a typical set-up of a client device 210 (a laptop computer in this case) with external accessories (mouse 220, dock 230). As shown FIG. 2, there can be regular interaction between on-device and external peripherals and the client device during its lifecycle. In day-to-day interaction, the client device can have potential issues arising due to system memory failure, poor platform performance and drastically high-power consumption; such issues may render the client device unusable. Such failures can be easily spotted by the user.

In the following, an imaginary scenario in the client device ecosystem is detailed, which may be observed when the client device is under use. For example, a client device may have a touchscreen and an onboard keyboard, which must be in working condition all the time. With an auto-update patch for the touchscreen and onboard keyboard driver that is not tested thoroughly, the touchscreen and onboard keyboard functionality may stop working (in the imaginary scenario). End-users might be aware of this potential issue only after the end user tries to perform interaction with client device using the touchscreen or onboard keyboard.

In another imaginary scenario, after a power state transition between cold boot, sleep or idle, the Bluetooth® driver might not be initialized successfully. Hence, when the end user of the client device is attempting to pairing a Bluetooth device during the conference call, the Bluetooth device might not pair with the client device.

Even if a desired component is enabled, a client device may be required to consistently meet local regulatory restrictions. For example, some countries do not allow 6 GHz band for Wi-Fi 802.11ax. In another example, there are operating constraints for power dissipation for a battery.

In other imaginary scenarios, external peripherals might be connected and yet not detected after power state transitions. For example, an external Thunderbolt™ dock may be connected, and then user puts device to sleep. After resuming the device, the Thunderbolt™ dock might not be detected.

In the existing client systems, telemetry data of device configuration is generally collected to understand user behavior (or platform hardware details) and is sent to a server to analyze it further for future usage. This creates added network traffic. Thus, client users may disable such data collection to avoid burdening the network. In these cases, there generally is no data analysis being done locally on the health and life cycle of the device. Moreover, the knowledge being gained might not be used to help improve the user experience and platform performance. Thus, in theses cases, there may be lack of actions taken upon collection of the telemetry data of device configuration with the purpose of improving system health and life cycle, leading to inefficient usage of platform resource and user experience.

The proposed concept may provide a mechanism to discover the ‘expected system configuration’ as a baseline to subsequently compare against the actual observed configuration (i.e., the current system configuration discussed in connection with FIGS. 1a to 1c). In turn, this provides an actionable insight to a user or information technology manager of the health or functionality of the product under observation.

Due to advancements of technology with multiple capabilities in client systems, more automated solutions may include self-sustained remote capability in the client platform to assist users to overcome errors, especially when the system is not connected to a network. In many cases, the client systems do not have the localized capability to notify the user and fix the issues in advance before the user uses a module/hardware. This lack of automated approaches is especially troublesome for technical users as well as non-professional usages. Thus, there may be a lack of methodology to manage the endpoint device efficiently at a managed stage where better efficiency and lesser turnaround is desired to avoid having an inefficient usage of platform resources and impact on user experience.

The proposed concept is going beyond the commonly implemented usages of Telemetry data, where enterprise administrators collect telemetry data from enterprise-enrolled devices, with the transmitted telemetry data being used, by enterprise administrators, to enforce policies, install OS update and extensions, or notify users to correct the behavior of usages. Other Telemetry concepts provided by Original Equipment Manufacturers (OEMs) and Independent Software Vendors (ISVs) are mostly enterprise-oriented and consist of collecting user activities, behavior, and habit information for personalizing the apps / devices. They also include collecting statistical data, identifying vulnerabilities or anomalies, and, based on the collected data, automatically or conditionally pushing auto-updates, upgrading system packages and/pr components. Other concepts may also discuss secure ways for performing over-the-air updates, finding anomalies, and analyzing for correlation with recent updates. If an anomaly is related to an update, source code files (or components) linked to the update may be found, and a User Interface (UI) may be provided for accessing correlated updates or source code files, and for communicate with update controller. For example, in a telemetry product that is specific to Chromebooks, an enterprise administrator collects the data through Google Cloud, which is used for enforcing policies, installing OS update sand extensions, or notifying users to correct usage behaviors.

However, existing telemetry products are mostly or entirely limited to enterprise devices. In these products, data is given to the administrator and not to the actual end users, who then take proper actions. Generally, personal devices do not have a way of knowing the health state of the device after updates/power state transitions. Its lack of self-awareness before executing remote provisioning or Intel® vPro® based manage options on enterprise laptops results in users being unaware of the potential issue. Most of the time when an issue occurs during update/power state transitions, subsystems of client device do not count consistently as per platform specifications, which may lead to an ineffective use of system resources and a bad user experience.

The proposed concept may provide an approach for finding static telemetry data and locally leveraging telemetry data of the device configuration to provide enhancements to the end user about the status and/or health of different underlying platform hardware, modules and/or components.

In the proposed concept, initial manifest Telemetry data of device configuration (i.e., the information on the expected system configuration) is pre-installed in a read-only memory (i.e., the protected storage) (can be called as primary copy), e.g., once the System Under Test (SUT) completes the power state transitions. This read-only copy of telemetry data can be treated as invariant data and may be always static. Read-only telemetry may be used for localized dynamic comparison against Telemetry data of device configuration (i.e., the information on the current system configuration) saved during normal usages in Read-Write region (can be called as secondary copy). The proposed concept may be invoked after a platform upgrade to identify potential issues arising from this comparison. It may notify in the notification area and suggestion/options to the end user, for resolving the potential issue with possible resolution.

As the proposed concept is implemented in client device itself, the following parameters may provide additional benefit compared to other, cloud-based telemetry products as shown in FIG. 3.

The proposed concept may avoid critical bottleneck scenarios with and without remote system management. In the proposed concept, first, Telemetry data of the device configuration is stored as read-only. This data remains static and invariant. Then, the concept dynamically queries Telemetry data of device configuration (i.e., the information on the current system configuration) and detect (any) deviations that may impact end user experience, the power envelope and/or the security of the device. The transitions used in the proposed concept are localized in nature. As there is no data exchange between a client and a telemetry server, privacy may be ensured. The proposed concept may be used to dynamically detect deviations from product requirements and to make remote manageability more effective. The proposed concept may also be used to help in dynamic detection of deviations from recommended security policies for the device, providing appropriate action in form of a notification. The proposed concept may effectively manage the system power envelop with this on-device detection process continuing to use client device in undesired state.

In various examples, the proposed concept requires no structural/hardware design change in the client computing device. As a result, there might not be a Bill of Materials (BOM) component added. The proposed concept may be used to provide the current health of the client device, showing status of (all of) the modules. For sake of privacy and security, user consent may be obtained once end-user reads End User License Agreement (EULA).

The proposed concept uses a primary and a secondary telemetry data copy. FIG. 3 shows an example of an implementation of primary and secondary telemetry data in a client device. FIG. 3 shows different layers within the client device - a user mode layer 310 (comprising an application for initiating and storing action on Telemetry data block 311 and a user applications block 312), a framework libraries layer 320 (comprising a primary Telemetry data (as read-only data) block 321, the secondary Telemetry data (as read/write data) block, an Intel SGX (Software Guard Extensions) block 323, a Telemetry aggregator daemon (part of Intel Data Collection and Analytics, DCA) block 324, and a core libraries block 325), a kernel model layer 330 (comprising an Intel SGX driver block 331, a Telemetry aggregator (part of Intel DCA) block 332, a core kernel block 333 and a device drivers block 334), an intermediate layer 340 between the kernel mode layer 330 and a hardware layer 350 (the intermediate layer comprising an ACRN (a hypervisor), ENCLS (Ring 0 of SGX) handler, EPC (Enclave Page Cache) management block 341 and an embedded controller block 342), and the hardware layer 350 (comprising an Intel SGX: EPC, EPCM (EPC Map) block 351, a Firmware (BIOS/Coreboot) block 352 and a platform hardware block 353). As shown in FIG. 3, block 311 (application for initiating and storing action on Telemetry data ) communicates with blocks 323 and 324 and block 312 (user applications) communicates with block 325. Block 323 (Intel SGX user runtime) communicates with blocks 321 (primary Telemetry copy), 322 (secondary Telemetry copy), 311 and 331. Block 324 (Telemetry aggregator daemon) communicates with blocks 311, 331 and 332. Block 325 (Core libraries) communicates with blocks 312 and 334. Block 331 (Intel SGX driver) communicates with blocks 323, 324, 332 and 341. Block 332 (Telemetry aggregator driver) communicates with blocks 324, 331, 333, 334, 342, 352 and 353. Block 333 (core kernel) communicates with blocks 332, 334, 342, 352 and 353. Block 334 (device drivers) communicates with blocks 325, 332, 333, 342 and 353. Block 341 (ACRN) communicates with blocks 331 and 351. Block 342 (embedded controller) communicates with blocks 332, 333, 334 and 353. Block 351 (Intel SGX) communicates with block 341. Block 352 (firmware) communicates with blocks 332, 333 and 353. Block 353 (platform hardware) communicates with blocks 332, 333, 334, 342 and 352.

As shown in FIG. 3, the primary copy 321 of Telemetry data of the device configuration is securely created at time of manufacturing the client computing device. Any hardware updates during usage of the client device can be modified using admin console. For example, the primary copy of Telemetry data may comprise details of functional driver versions, configuration settings, and mapping to working OS version and OS patches. This data may act as a master reference copy of working configuration of system OS/drivers/configuration settings. For example, the primary copy may be stored (securely) in standard JavaScript Object Notation (JSON) format.

As further shown in FIG. 3, the secondary copy 322 of the telemetry data of device configuration may be the most recently captured copy that is created based on customizable triggers. The secondary telemetry data 322 may be created with a reduced or minimal impact on system resources. For example, the second telemetry data 322 may be created after power state transitions (sleep-resume, restart, boot). For example, one or more of the following configurability options may be used. Such as creation of secondary telemetry data copy only when system is in battery-charging mode, or when the system is idle (to avoid unwanted CPU load), or for specific components only (to reduce unwanted overheads to system resources) or at a scheduled interval. Content-wise and format-wise, the secondary telemetry data may be implemented like the primary copy.

Data Collection and Analytics (DCA) is an Intel-developed capability to efficiently gather, analyze and use data for fleet intelligence. Distinguishing features of DCA vs. other telemetry frameworks are explicit initial user consent for privacy and security, low performance overhead (estimated to be <0.5% of CPU), portability across stack from Internet of Things (IOT) devices to client devices to the data center and cross OS support for Windows & Linux. It may support expandable collection, as the collector is modular and additional collection & analysis modules, detailed below, to allow customers to collect and interpret specific system information and usage metrics.

In a specific implementation of the proposed concept, the telemetry daemon 324 leverages the Intel Data Collection and Analytics (DCA) framework to maintain the primary telemetry data copy 321 of the device configuration (as read-only) and the secondary telemetry data copy 322 of the device configuration (as read/write). The intention of the telemetry daemon 324 may be to detect problems, predict impacts and provide information to users for corrective actions. The scope of this daemon may be to detect software-detectable errors. For example, a specific device driver not being functional after certain events like system restart, system resume from sleep or OS patch upgrade - here, the daemon may also help to compare the impact of non-functional/faulty device to end user in the notification area.

FIG. 4 shows a flow chart of an example of the primary and secondary telemetry data flow. As shown in FIG. 4 400, two preconditions may be met - the daemon may run on the SUT (System under Test) and the required needed configurations are set, and the latest version of the primary telemetry data may be saved, e.g., in the file system (the daemon may store and keep a reference to this copy). When a trigger is received 410 (trigger events may include one or more of power on SUT shutdown/restart events, power state transition events (sleep-resume), reboots after auto-update, reboots after system crash/hangs/recovery), firmware and kernel verification are performed 420. If there is a power state transition, it is checked whether the secondary telemetry data is already collected - if not, the secondary telemetry data is collected 430 then. Subsequently, it is determined whether the secondary telemetry data is the same as the primary telemetry data. If they are the same, or if there is no power state transition, no action is taken 440. If the primary and secondary copy are not the same, and the daemon has not detected a problem, no action is taken 440. If the daemon has detected a problem, one or more of an impact prediction, problem solution and post problem correction (if successful) are performed. In impact prediction, the impact of the problem may be notified by the daemon to the user via a log entry, a user interface or a notification mechanism. In problem solution, three different courses of action can be taken - the user can ignore the problem, the user manually takes corrective action, or the daemon auto-corrects problems (in a user-configurable manner), e.g., by rolling back to a previous functional driver for the failure component. In post-problem correction, the primary telemetry copy may be updated using the secondary telemetry data copy.

As shown in FIG. 4, the daemon compares the primary and secondary telemetry data copy. If it finds a difference between both copies (meaning, there is change in version of some components) - the daemon may run additional error checks to detect anomalies in any component which could potentially make it non-functional or perform in a degraded manner. When such a component is detected, the user may be notified of the same in the notification area. As a remedy to detected problem, the user may be given the option to auto-correct the functionality of the broken/failing component (e.g., by reverting to a working functional component using primary telemetry data reference) or to manually correct the component (manually roll back to old driver or update to additional new driver if available).

In the following, some possible outcomes of comparing the primary copy (read-only) and the secondary copy (read-write) are given. If the primary copy not present, the end-user may be informed, and the software support system may be informed through an OS feedback mechanism or SUT feedback mechanism. Users may be allowed to mask the notification temporarily or permanently. If the secondary copy is not present, the end-user may be informed, as this may relate to a potential issue, so workable solutions may be provided. The software support system may be informed through the OS feedback mechanism or SUT feedback mechanism. Users may be allowed to mask the notification temporarily or permanently. If the primary copy is the same as the secondary copy, no action might be taken. If items are missing in the primary copy, but present in the secondary copy (e.g., in the audio device tree), the end-user may be informed, and the software support system may be informed through the OS feedback mechanism or SUT feedback mechanism. Users may be allowed to mask the notification temporarily or permanently. If items are missing in the secondary copy, but present in primary copy (e.g., within the audio device tree), the end-user may be informed, as this may relate to a potential issue, so workable solutions may be provided. The software support system may be informed through the OS feedback mechanism or SUT feedback mechanism. Users may be allowed to mask the notification temporarily or permanently. If there is an items mismatch between the primary copy and the secondary copy (e.g., relating to the 3.5 mm audio device node), the end-user may be informed as this may relate to a potential issue, so workable solutions may be provided. The software support system may be informed through the OS feedback mechanism or SUT feedback mechanism. Users may be allowed to mask the notification temporarily or permanently.

The daemon may have one or more of the following user configuration options, which may improve the overall concept to be highly flexible. For example, for the sake of privacy and security, user consent may be obtained, once end-user reads the EULA. The user may have the option of completely enabling or disabling the daemon (enabling may help user make use of the proposed concept, while disabling daemon may disable the proposed concept). An option may be given to run daemon execution in battery-charging mode (Alternating Current, AC mode) only or battery-only mode (Direct Current, DC, mode), or both AC and DC mode (with the flexibility to run the daemon based on needs/system resource conservation). The user may have the option to generate and compare telemetry data after specific triggers/events, e.g., user can select when to do telemetry data comparisons e.g., after a restart, after resume from sleep, after resume from hibernate, after an auto-update (OS/driver patches) or after any system crash/hangs/recovery. User can select all or a subset of triggers/events. The daemon may categorize the issues based on the criticality and notify the end user accordingly, whereby the end user can take the action based on the priority of the issue.

Telemetry data may be captured from the hardware platform for power (CPU, system memory etc.), performance (CPU, cache memory etc.), thermal, Peripheral Component Interconnect Express (PCIe) interfaces etc. Telemetry data may be captured using Intel Data Collection and Analytics (DCA) capability, with aid of model-specific registers (MSRs) and existing onboard sensors. This may help to obtain a negligible perceived latency and negligible CPU load. The proposed concept might not collect any personally identifiable information such as name, email address, IP address, MAC address, user details. The proposed algorithm of efficient endpoint manageability can be performed inside AI (Artificial Intelligence) solutions that can be integrated into Intel® Architecture (IA) SoC and may be an effective approach across various platforms without any changes in system BIOS or OS infrastructure.

End users may obtain the information about the issue showing the criticality of the issue in the client device early in the notification area. The user can then selectively choose what corrective actions are to be performed based on the criticality of the issue. Using the proposed concept, a suitable or best approach for dealing with each of the unique issues the device has gone through may be provided, along with the following advantages. For example, the user may be notified of (all of) the possible discrepancies in an OS supplied notification area. A suitable or best approach for dealing with the underlying issue is suggested, which the user can start by interacting with the user space application. For example, recommendations may be tailored to platform under use. The proposed concept may suggest reverting to a previous known/working OS, when the components after software update shows anomalies, which may be an early indicator of points of component/system failure.

More details and aspects of the concept for defining a software-readable expected system configuration are mentioned in connection with the proposed concept or one or more examples described above or below (e.g., FIGS. 1a to 1c). The concept for defining a software-readable expected system configuration may comprise one or more additional optional features corresponding to one or more aspects of the proposed concept, or one or more examples described above or below.

In the following, some examples of the proposed concept are presented:

An example (e.g., example 1) relates to an apparatus (10) for a computer system (100), the apparatus comprising interface circuitry (12), machine-readable instructions and processing circuitry (14) to execute the machine-readable instructions to obtain information on an expected system configuration of the computer system (100) from a protected storage (101) of the computer system. The machine-readable instructions comprise instructions to determine information on a current system configuration of the computer system. The machine-readable instructions comprise instructions to compare the expected system configuration with the current system configuration. The machine-readable instructions comprise instructions to provide information on a mismatch via an output device (105) of the computer system if there is a mismatch between the expected system configuration and the current system configuration.

Another example (e.g., example 2) relates to a previously described example (e.g., example 1) or to any of the examples described herein, further comprising that the machine-readable instructions comprise instructions to determine the information on the current system configuration after a power state transition of the computer system.

Another example (e.g., example 3) relates to a previously described example (e.g., example 2) or to any of the examples described herein, further comprising that the machine-readable instructions comprise instructions to determine the information on the current system configuration after the computer system transitions from a sleep state to an active state.

Another example (e.g., example 4) relates to a previously described example (e.g., one of the examples 2 to 3) or to any of the examples described herein, further comprising that the machine-readable instructions comprise instructions to determine the information on the current system configuration after or during a boot process of the computer system.

Another example (e.g., example 5) relates to a previously described example (e.g., one of the examples 1 to 4) or to any of the examples described herein, further comprising that the machine-readable instructions comprise instructions to determine the information on the current system configuration according to a pre-defined schedule.

Another example (e.g., example 6) relates to a previously described example (e.g., one of the examples 1 to 5) or to any of the examples described herein, further comprising that the machine-readable instructions comprise instructions to determine the information on the current system configuration when a power condition is met.

An example (e.g., example 7) relates to a The apparatus according to one of the examples 1 to 6, wherein the machine-readable instructions comprise instructions to determine the information on the current system configuration by querying at least one of a system firmware (102) of the computer system, a hardware component (103) of the computer system, an embedded controller (104) of the computer system, a kernel of an operating system of the computer system and a driver of a hardware component (103) of the computer system.

Another example (e.g., example 8) relates to a previously described example (e.g., one of the examples 1 to 7) or to any of the examples described herein, further comprising that the information on the mismatch is provided in at least one of the following cases if a hardware component is present in the expected configuration and missing in the current configuration, if a hardware component is missing in the expected configuration and present in the current configuration, and if a hardware component has a different configuration between the expected configuration and the expected configuration.

Another example (e.g., example 9) relates to a previously described example (e.g., one of the examples 1 to 8) or to any of the examples described herein, further comprising that the machine-readable instructions comprise instructions to determine, based on a data storage with proposed mitigations, information on a proposed mitigation for mitigating the mismatch, and to include the information on the proposed mitigation with the information on the mismatch.

Another example (e.g., example 10) relates to a previously described example (e.g., one of the examples 1 to 9) or to any of the examples described herein, further comprising that the machine-readable instructions comprise instructions to determine, based on a data storage with known impacts, information on a likely impact of the mismatch, and to include the information on the likely impact with the information on the mismatch.

Another example (e.g., example 11) relates to a previously described example (e.g., one of the examples 1 to 10) or to any of the examples described herein, further comprising that the expected and current system configuration relate to internal components of the computer system.

Another example (e.g., example 12) relates to a previously described example (e.g., one of the examples 1 to 11) or to any of the examples described herein, further comprising that the expected and current system configuration relate to non-peripheral components of the computer system.

Another example (e.g., example 13) relates to a previously described example (e.g., one of the examples 1 to 12) or to any of the examples described herein, further comprising that the information on the expected system configuration and the information on the current system configuration comprise telemetry data.

Another example (e.g., example 14) relates to a previously described example (e.g., one of the examples 1 to 13) or to any of the examples described herein, further comprising that the expected system configuration is a factory-defined system configuration of the computer system.

Another example (e.g., example 15) relates to a previously described example (e.g., one of the examples 1 to 14) or to any of the examples described herein, further comprising that the protected storage (101) is a read-only storage of the computer system.

Another example (e.g., example 16) relates to a previously described example (e.g., one of the examples 1 to 15) or to any of the examples described herein, further comprising that the expected system configuration is a factory-defined system configuration of the computer system that is modifiable by an administrator of the computer system.

Another example (e.g., example 17) relates to a previously described example (e.g., example 16) or to any of the examples described herein, further comprising that the protected storage (101) is a storage that is overwritable by an administrator of the computer system.

Another example (e.g., example 18) relates to a previously described example (e.g., one of the examples 16 to 17) or to any of the examples described herein, further comprising that the machine-readable instructions comprise instructions to detect a change in the system configuration of the computer system, authenticate an administrator of the computer system, and overwrite the expected system configuration based on the detected change in the system configuration and based on the authentication of the administrator of the computer system.

An example (e.g., example 19) relates to an apparatus (10) for a computer system (100), the apparatus comprising processing circuitry (14) to obtain information on an expected system configuration of the computer system (100) from a protected storage (101) of the computer system. The processing circuitry is to determine information on a current system configuration of the computer system. The processing circuitry is to compare the expected system configuration with the current system configuration. The processing circuitry is to provide information on a mismatch via an output device of the computer system if there is a mismatch between the expected system configuration and the current system configuration.

An example (e.g., example 20) relates to a device (10) for a computer system (100), the device comprising means for processing (14) for obtaining information on an expected system configuration of the computer system (100) from a protected storage (101) of the computer system. The means for processing is for determining information on a current system configuration of the computer system. The means for processing is for comparing the expected system configuration with the current system configuration. The means for processing is for providing information on a mismatch via an output device of the computer system if there is a mismatch between the expected system configuration and the current system configuration.

An example (e.g., example 21) relates to a method for a computer system (100), the method comprising obtaining (110) information on an expected system configuration of the computer system (100) from a protected storage (101) of the computer system. The method comprises determining (120) information on a current system configuration of the computer system. The method comprises comparing (130) the expected system configuration with the current system configuration. The method comprises providing (160) information on a mismatch via an output device of the computer system if there is a mismatch between the expected system configuration and the current system configuration.

Another example (e.g., example 22) relates to a previously described example (e.g., example 21) or to any of the examples described herein, further comprising that the method comprises determining (120) the information on the current system configuration after a power state transition of the computer system.

Another example (e.g., example 23) relates to a previously described example (e.g., example 22) or to any of the examples described herein, further comprising that the method comprises determining (120) the information on the current system configuration after the computer system transitions from a sleep state to an active state.

Another example (e.g., example 24) relates to a previously described example (e.g., one of the examples 22 to 23) or to any of the examples described herein, further comprising that the method comprises determining (120) the information on the current system configuration after or during a boot process of the computer system.

Another example (e.g., example 25) relates to a previously described example (e.g., one of the examples 21 to 24) or to any of the examples described herein, further comprising that the method comprises determining (120) the information on the current system configuration according to a pre-defined schedule.

Another example (e.g., example 26) relates to a previously described example (e.g., one of the examples 21 to 25) or to any of the examples described herein, further comprising that the method comprises determining (120) the information on the current system configuration when a power condition is met.

Another example (e.g., example 27) relates to a previously described example (e.g., one of the examples 21 to 26) or to any of the examples described herein, further comprising that the method comprises determining (120) the information on the current system configuration by querying (125) at least one of a system firmware (102) of the computer system, a hardware component (103) of the computer system, an embedded controller (104) of the computer system, a kernel of an operating system of the computer system and a driver of a hardware component (103) of the computer system.

Another example (e.g., example 28) relates to a previously described example (e.g., one of the examples 21 to 27) or to any of the examples described herein, further comprising that the method comprises determining (150), based on a data storage with proposed mitigations, information on a proposed mitigation for mitigating the mismatch, and to include the information on the proposed mitigation with the information on the mismatch.

Another example (e.g., example 29) relates to a previously described example (e.g., one of the examples 21 to 28) or to any of the examples described herein, further comprising that the method comprises determining (140), based on a data storage with known impacts, information on a likely impact of the mismatch, and to include the information on the likely impact with the information on the mismatch.

Another example (e.g., example 30) relates to a previously described example (e.g., one of the examples 21 to 29) or to any of the examples described herein, further comprising that the expected system configuration is a factory-defined system configuration of the computer system that is modifiable by an administrator of the computer system, and wherein the method comprises detecting (132) a change in the system configuration of the computer system, authenticate (136) an administrator of the computer system, and overwriting (136) the expected system configuration based on the detected change in the system configuration and based on the authentication of the administrator of the computer system.

An example (e.g., example 31) relates to a computer system comprising an apparatus or device according to one of the examples 1 to 20 (or according to any other example).

An example (e.g., example 32) relates to a computer system being configured to perform the method according to one of the examples 21 to 30 (or according to any other example).

An example (e.g., example 33) relates to a non-transitory machine-readable storage medium including program code, when executed, to cause a machine to perform the method of one of the examples 21 to 30 (or according to any other example).

An example (e.g., example 34) relates to a computer program having a program code for performing the method of one of the examples the method of one of the examples 21 to 30 (or according to any other example) when the computer program is executed on a computer, a processor, or a programmable hardware component.

An example (e.g., example 35) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for a computer system, the apparatus comprising interface circuitry, machine-readable instructions and processing circuitry to execute the machine-readable instructions to:
obtain information on an expected system configuration of the computer system from a protected storage of the computer system;
determine information on a current system configuration of the computer system;
compare the expected system configuration with the current system configuration; and
provide information on a mismatch via an output device of the computer system if there is a mismatch between the expected system configuration and the current system configuration.

2. The apparatus according to claim 1, wherein the machine-readable instructions comprise instructions to determine the information on the current system configuration after a power state transition of the computer system.

3. The apparatus according to claim 2, wherein the machine-readable instructions comprise instructions to determine the information on the current system configuration after the computer system transitions from a sleep state to an active state.

4. The apparatus according to claim 2, wherein the machine-readable instructions comprise instructions to determine the information on the current system configuration after or during a boot process of the computer system.

5. The apparatus according to claim 1, wherein the machine-readable instructions comprise instructions to determine the information on the current system configuration according to a pre-defined schedule.

6. The apparatus according to claim 1, wherein the machine-readable instructions comprise instructions to determine the information on the current system configuration when a power condition is met.

7. The apparatus according to claim 1, wherein the machine-readable instructions comprise instructions to determine the information on the current system configuration by querying at least one of a system firmware of the computer system, a hardware component of the computer system, an embedded controller of the computer system, a kernel of an operating system of the computer system and a driver of a hardware component of the computer system.

8. The apparatus according to claim 1, wherein the information on the mismatch is provided in at least one of the following cases: if a hardware component is present in the expected configuration and missing in the current configuration, if a hardware component is missing in the expected configuration and present in the current configuration, and if a hardware component has a different configuration between the expected configuration and the expected configuration.

9. The apparatus according to claim 1, wherein the machine-readable instructions comprise instructions to determine, based on a data storage with proposed mitigations, information on a proposed mitigation for mitigating the mismatch, and to include the information on the proposed mitigation with the information on the mismatch.

10. The apparatus according to claim 1, wherein the machine-readable instructions comprise instructions to determine, based on a data storage with known impacts, information on a likely impact of the mismatch, and to include the information on the likely impact with the information on the mismatch.

11. The apparatus according to claim 1, wherein the expected and current system configuration relate to internal components of the computer system.

12. The apparatus according to claim 1, wherein the expected and current system configuration relate to non-peripheral components of the computer system.

13. The apparatus according to claim 1, wherein the information on the expected system configuration and the information on the current system configuration comprise telemetry data.

14. The apparatus according to claim 1, wherein the expected system configuration is a factory-defined system configuration of the computer system.

15. The apparatus according to claim 1, wherein the protected storage is a read-only storage of the computer system.

16. The apparatus according to claim 1, wherein the expected system configuration is a factory-defined system configuration of the computer system that is modifiable by an administrator of the computer system.

17. The apparatus according to claim 16, wherein the protected storage is a storage that is overwritable by an administrator of the computer system.

18. The apparatus according to claim 16, wherein the machine-readable instructions comprise instructions to detect a change in the system configuration of the computer system, authenticate an administrator of the computer system, and overwrite the expected system configuration based on the detected change in the system configuration and based on the authentication of the administrator of the computer system.

19. A computer system comprising an apparatus according to claim 1.

20. A method for a computer system, the method comprising:
obtaining information on an expected system configuration of the computer system from a protected storage of the computer system;
determining information on a current system configuration of the computer system;
comparing the expected system configuration with the current system configuration; and
providing information on a mismatch via an output device of the computer system if there is a mismatch between the expected system configuration and the current system configuration.

21. A non-transitory machine-readable storage medium including program code, when executed, to cause a machine to perform the method of claim 20.
